(19) United States
(12) Patent Application Publication
(10) Pub. No.: US 2026/0119538 A1
(43) Pub. Date: Apr. 30, 2026

(54) SYSTEM AND METHOD FOR PERFORMING KEYWORD-ASSISTED SEMANTIC SEARCHING

(71) Applicant: INTUIT INC., Mountain View, CA (US)

(72) Inventors: Pankaj RASTOGI, Mountain View, CA (US); Spriha AWASTHI, Mountain View, CA (US); Deepak KUMAR, Mountain View, CA (US)

(73) Assignee: INTUIT INC., Mountain View, CA (US)

(21) Appl. No.: 18/932,662

(22) Filed: Oct. 31, 2024

(51) Int. Cl. G06F 16/332; G06F 16/33; G06F 16/383

(52) U.S. Cl. CPC G06F 16/3329; G06F 16/3347; G06F 16/383

(57) ABSTRACT

A system and method are provided for performing keyword-assisted semantic searching.

### BACKGROUND OF THE DISCLOSURE

Many modern organizations utilize vector databases that enable storage and retrieval of embeddings. For example, the vector database can store embedded documents, records, knowledge forms, and various other types of information within a vector space. In addition, such vector databases enable semantic searches to be performed across what is contained within. However, in instances where a user is attempting to search the vector database and the search query contains entities that are “meaningless,” such as a Document ID, email address, or other ID number, the search results returned to the user may not be as accurate as desired. This can lead to inefficiencies and reduced productivity for users looking to retrieve specific information from the database, which is also undesirable. Finally, vector database queries generally have inherent approximations as a tradeoff (e.g., by using approximate k-nearest neighbor algorithms) and therefore some granular details contained within a search query can be lost, which is similarly undesirable.

### BRIEF DESCRIPTION OF THE FIGURES

FIG. 1 is a block diagram of an example system for performing keyword-assisted semantic searching according to example embodiments of the present disclosure.

FIG. 2 is a flowchart of an example process for performing keyword-assisted semantic searching according to example embodiments of the present disclosure.

FIG. 3 is an example architectural flow for performing keyword-assisted semantic searching according to example embodiments of the present disclosure.

FIG. 4 is an example hybrid query according to example embodiments of the present disclosure.

FIG. 5 is server that can be used within the system of FIG. 1 according to an embodiment of the present disclosure.

FIG. 6 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure are directed to a system and method for performing keyword-assisted semantic searching within a vector database. The disclosed principles can persist certain keywords or other entities (e.g., email address, asset_id, etc.) as metadata within the vector database that can ultimately be used to complement and assist with semantic searches. In some embodiments, the entities can be manually defined by a user and/or automatically extracted from various documents by a large language model (LLM) prior to searches being performed. The disclosed system and method can utilize such entities in two ways. First, the disclosed system and method can create a hybrid query based on a received user query that also takes into account identified entities when performing a semantic search across the vector database. Second, the disclosed system and method can pre-filter the documents within the vector database based on identified entities prior to the semantic searching being performed. This can significantly enhance the accuracy and relevance of search results.

In some embodiments, the disclosed techniques can be utilized in a retrieval augmented generation (RAG) context. For example, in a chatbot or other type of question-answering platform that a user can engage with, once the user's question has been received, the disclosed techniques can be applied to find the most relevant information to the query from within the vector database. Then, the query and information identified from the vector database can be fed to an LLM to generate a conversational response that is transmitted back to the user.

By answering inquiries (e.g., via a chatbot, phone call) using vector embeddings and large language models (LLMs), the disclosed systems and methods can leverage vector embeddings and the generative artificial intelligence of LLMs to facilitate real-time or near real-time access to topic-specific-related information for various users, including both consumers and consumer-facing professionals, such as a tax professional interacting with a consumer over the phone or via chatbot. The system can identify a user query and identify portions of an embedded dataset relevant to the query via various similarity analysis techniques. The system can provide the original user query and identified relevant information as an input to an LLM. The LLM can provide a quick and accurate response to the question, and the system can provide this response to the user.

Moreover, the disclosed system and method can increase the accuracy and computational efficiency in which vector databases are searched by 1) modifying the similarity scoring analysis to include keyword-based scoring; and 2) reducing the size of the vector space that is being searched.

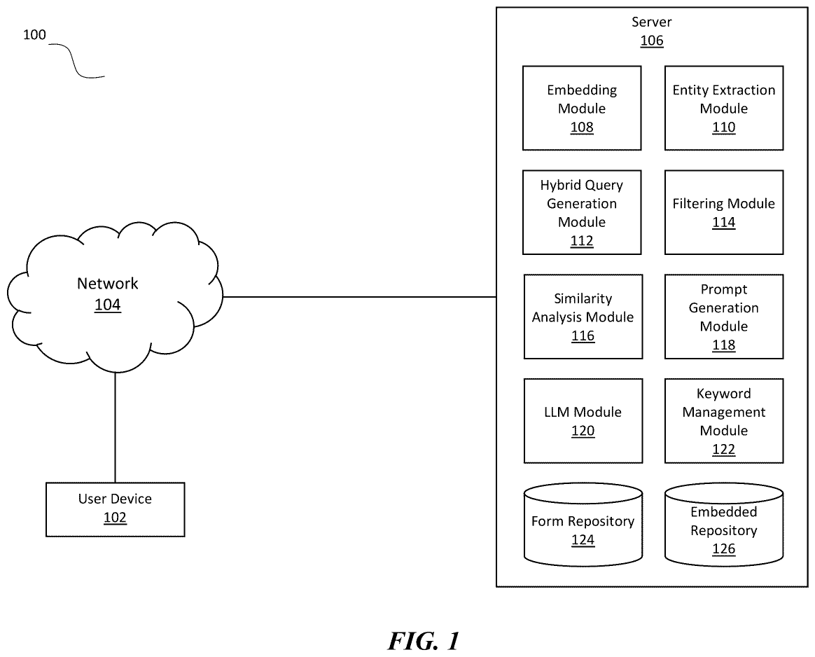

FIG. 1 is a block diagram of an example system 100 for performing keyword-assisted semantic searching according to example embodiments of the present disclosure. The system 100 can include one or more user devices 102 (generally referred to herein as a “user device 102” or collectively referred to herein as “user devices 102”) that can access a server 106 via a network 104 to facilitate communication and engage with a question-answer service contained therein. In some embodiments, the question-answer service can be a chatbot. In some embodiments, the system 100 can include any number of user devices 102. For example, for a financial or accounting platform or other website that may offer services to users, there may be an extensive userbase with thousands or even millions of users that connect to the system 100 via their user devices 102 allowing them to ask questions via e.g., a chatbot. The server 106 can provide responses to user questions utilizing the principles disclosed herein.

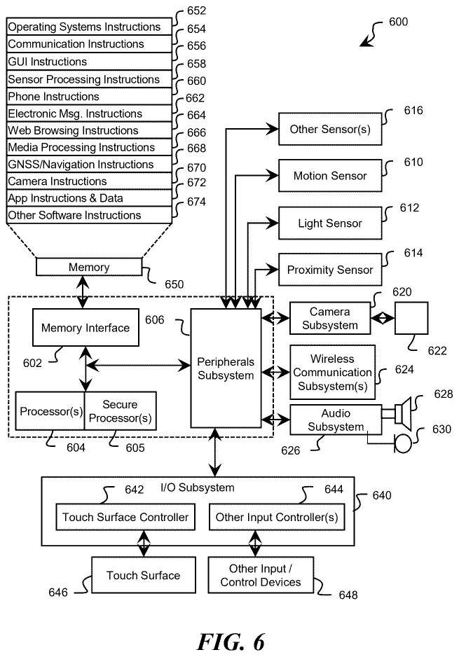

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the computing device 600 described below with respect to FIG. 6.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

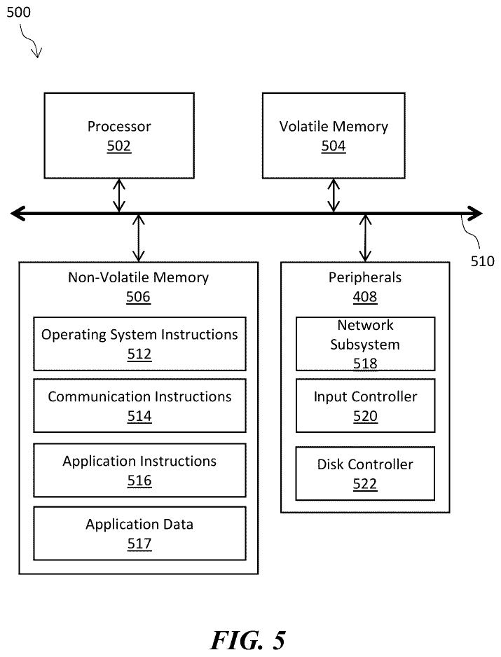

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 500 described below with respect to FIG. 5.

As shown in FIG. 1, the server 106 can include an embedding module 108, an entity extraction module 110, a hybrid query generation module 112, a filtering module 114, a similarity analysis module 116, an prompt generation module 118, an LLM module 120, a keyword management module 122, a form repository 124, and an embedded repository 126.

In one or more embodiments the embedding module 108 is configured to embed text to vector form within a vector space, such as a continuous vector space. The embedding module 108 can receive text, such as a user inquiry from the user device 102 and generate an embedding of the received text. In addition, the embedding module 108 is configured to embed documents from the form repository 124 to the vector space so that they are stored within the embedded repository 126. In some embodiments, the embedding module 108 can utilize a variety of embedding techniques, such as e.g., a word2vec model. The word2vec model may be pre-trained on various large corpuses of text and data. In some embodiments, the word2vec model may use a continuous bag-of-words approach (CBOW). The word2vec model may be configured to create a “bag-of-words” for each description. A bag-of-words for a description may be a set (e.g., JSON object) that includes every word in the user inquiry and the multiplicity (e.g., the number of times the word appears in the description) of each word. The word2vec model can be configured to predict a vector representation of each word using the context of the word's usage in the inquiry. For example, the word2vec model may consider the surrounding words and the multiplicities but may not use grammar or the order of the words in the description. In some embodiments, the embedding module 108 may include an encoder and/or a neural network architecture to perform the embedding processes.

In some embodiments, the embedding module 108 may use a word2vec model with a skip-gram approach, where the skip-gram approach predicts a focus word within a phrase or sentence. The pre-trained word vectors may be initially trained on a variety of sources, such as e.g., Google News and Wikipedia. In some embodiments, the embedding module 108 may employ other word embedding frameworks such as GloVe (Global Vector) or FastText. GloVe techniques may, rather than predicting neighboring words (CBOW) or predicting the focus word (skip-gram), embed words such that the dot product of two-word vectors is close to or equal to the log of the number of times appear near each other.

In addition, it is important to note that the disclosed embedding techniques are not limiting and that a variety of other applicable embedding techniques that are known by those of ordinary skill in the art could be used.

In some embodiments, the entity extraction module 110 is configured to extract entities from a received user query. In some embodiments, the entity extraction module 110 can extract entities from a received user query based on a pre-defined configuration of entities. For example, a user, via user device 102, can transmit a configuration to the server 106 that contains a list of unique identities that the system should extract when subsequent user queries are received. An example entity could be a document ID or other unique identifier that typically would not have much lexical or semantic meaning for a vector-based system to focus on and search for. In some embodiments, the entity extraction module 110 is also configured to extract entities from document chunks and other material contained within the form repository 124. For example, the entity extraction module 110 can employ an LLM, which can be an LLM separate from the LLM module 120, to identify and extract keywords/entities from the various document chunks and materials contained within the form repository 124. In some embodiments, the LLM within the entity extraction module 110 can extract entities in a zero-shot fashion.

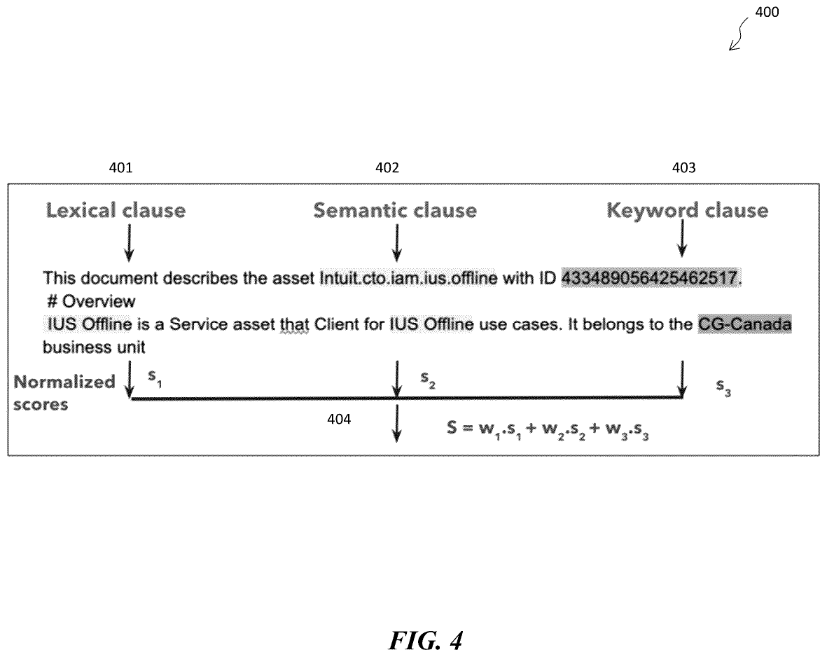

In some embodiments, the hybrid query generation module 112 is configured to generate a hybrid query based on the received user query and the entities extracted from the user query by the entity extraction module 110. An example hybrid query is shown in FIG. 4 (discussed in more detail below). In some embodiments, the hybrid query generation module 112 can merge various queries into a single hybrid query such that it can be executed, normalized, and merged to provide a single result. For example, a hybrid query can include a lexical clause, a semantic clause, and a keyword clause. In some embodiments, the lexical clause can include the exact terms or phrases specified in user query that can be used for identifying documents in Vector DB. Generating the lexical clause can be performed using simple string-matching algorithms. The semantic clause can include semantic signals detected and extracted from the user query. The keyword clause can include one or more entities extracted from the user query by the entity extraction module 110.

In some embodiments, the filtering module 114 is configured to pre-filter the vector space (i.e., the embedded repository 126) before a semantic vector search is executed on the embedded repository 126. For example, as entities extracted by the entity extraction module 110 are maintained as metadata within the embedded repository 126, the filtering module 114 can pre-filter embedded documents within the embedded repository 126 such that only documents containing the stored entities are ultimately semantically searched.

In addition, the form repository 124 is configured to operate as a database and/or knowledge base of information relevant to certain specialty areas. For instance, in the field of tax and accounting, the form repository 124 can include a plurality of tax forms, tax instructions, business tax-related documents (e.g., for U.S. states), tax data models, tax calculation logic, interview files, etc. In some embodiments, the form repository 124 can be continuously updated to reflect year-over-year changes throughout the knowledge base. Moreover, the embedding module 108 is configured to process the dataset contained within the form repository 124 to generate embeddings thereof, which can enable capture of the relationships between various tax documents and an efficient extraction of information. Once the dataset contained within the form repository 124 is embedded, it can be stored in the embedded repository 126.

In some embodiments, the embedded repository 126 is a vector store that can be fine-tuned for efficient data retrieval and management. One such example is a Chroma Database. In some embodiments, the embedded repository 126 can employ one or more of indexing and querying techniques that can be used for hierarchical clustering or partitioning. The use of such indexing and querying techniques can enable parallel processing, caching, and prefetching, which can minimize latency to store frequently accessed data in memory. Moreover, this can provide data compression via e.g., Apache® Parquet and efficient storage without sacrificing query performance with fault tolerance and recovery.

In some embodiments, the similarity analysis module 116 is configured to perform various similarity techniques and algorithms on e.g., an embedded user inquiry generated by the embedding module 108 and the embedded dataset contained within the embedded repository 126. In some embodiments, the similarity analysis module 116 can use a cosine similarity-based analysis within the vector store. For example, the similarity analysis module 116 can, based on the embedded user inquiry, rank and retrieve the top “n” most relevant documents within the embedded repository 126. In some embodiments, the similarity analysis module 116 can be trained on a corpus of documents, such as a corpus of tax documents when the system 100 implements a tax or accounting service. The corpus of documents can include pairs of sentences or phrases along with their similarity scores or labels. In addition, a representative feature vector for each sentence or phrase can be generated using various word embedding techniques or language models. These can then be split into training and validation sets. In some embodiments, a cosine similarity technique can be used to calculate a similarity level between feature vectors of the sentence or phrase pairs in the training set and, optionally, the scores can be normalized between zero and one. Then, a machine learning model (e.g., neural network) can be trained to predict a similarity score based on these sentence or phrase pairs and corresponding cosine similarity scores. In some embodiments, the machine learning model can be trained using techniques such as backpropagation and gradient descent to adjust the model's weights and biases. In addition, the similarity analysis module 116 is configured to calculate normalized similarity scores based on the entities included in the hybrid search. In some embodiments, combined score for each document can be a combination of the keyword match score (i.e., the score representing the level of similarity between the identified keywords in the query and the keywords in the search result), the vector similarity score (i.e., the score representing the level of similarity between the lexical clause and text within the search result), and a lexical score (i.e., the score representing the relevance of a textual phrase in a result to the lexical clause). In some embodiments, the lexical score can be computed using a best match 25 algorithm. In some embodiments, the combined score can be calculated using a weighted sum where different weights can be assigned to the contribution from the keyword match score, the vector similarity score, and the lexical score.

In some embodiments, the prompt generation module 118 is configured to generate an input that can be fed into an LLM (e.g., LLM module 120). For example, the prompt generation module 118 can analyze the results and/or output of the similarity analysis module 116 and add specific knowledge or other information extracted from the determined forms or documents to a prompt that includes the original user inquiry. In some embodiments, the prompt generation module 118 can be configured to perform a contextual query expansion on the original user inquiry to generate a set of semantically related terms and/or phrases. This set of terms and/or phrases can be added to the LLM input. The resulting input can therefore include the original user inquiry and additional information defining a subset of forms or other information (as determined by the similarity analysis module 116); this input can be fed to the LLM module 120.

In some embodiments, the LLM module 120 can include an LLM, such as GPT-3, -3.5, -4, PaLM-E, Ernie Bot, LLaMa, and others. In some embodiments, the LLM can include various transformed-based models trained on vast corpuses of data that utilize an underlying neural network. The LLM module 120 can receive an input, such as the input generated by the prompt generation module 118. The LLM module 120 is configured to analyze the input to answer the original user inquiry. In some embodiments, the LLM module 120 can be fine-tuned using few shot learning with examples specifying how to respond to customer queries and how to provide proper tone, clarity, and specificity.

In some embodiments, the keyword management module 122 is configured to monitor and modify the metadata maintained within the embedded repository 126. For example, the keyword management module 122 is configured to persist entities as metadata within the embedded repository 126. This can include entities that have been pre-defined in a configuration by a user or entities that have been identified by the entity extraction module 110.

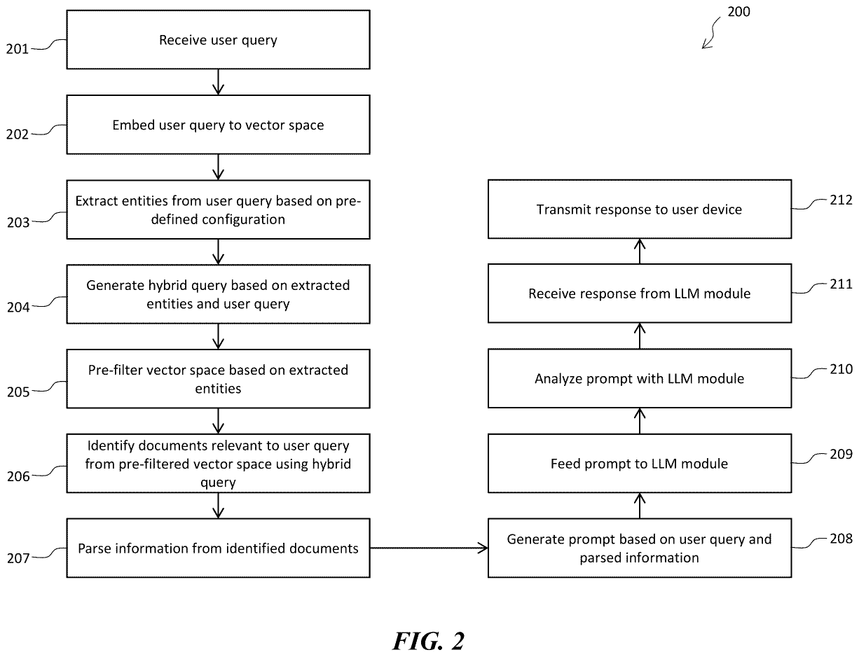

FIG. 2 is a flowchart of an example process 200 for performing keyword-assisted semantic searching according to example embodiments of the present disclosure. In some embodiments, the process 200 can be performed by the server 106 in conjunction with a question-answer system that a user is engaging with via the user device 102.

At block 201, the server 106 receives a user query from a user device 102. For example, the user of the user device 102 can be engaging with a chatbot system or other question-answer system. Once the user enters a query, it is transmitted over the network 104 to the server 106 for processing. At block 202, the embedding module 108 embeds the user query to a vector space. In some embodiments, this can include converting the text of the user query to a vector format. The embedding module 108 may perform the embedding procedure via various embedding techniques, such as those discussed above in relation to FIG. 1.

At block 203, the entity extraction module 110 extracts one or more entities from the received user query based on a pre-defined configuration. In some embodiments, the pre-defined configuration can include a list of unique identities specified by a user. In addition, the pre-defined configuration can include various entities that have been previously identified and extracted from the documents within the form repository 124. As discussed above in relation to FIG. 1, the entity extraction module 110 can utilize an LLM to extract entities from document chunks and other material contained within the form repository 124. In some embodiments, the LLM within the entity extraction module 110 can extract entities in a zero-shot fashion.

At block 204, the hybrid query generation module 112 generates a hybrid query based on the one or more extracted entities and the original user query. In some embodiments, the hybrid query generation module 112 can merge various queries into a single hybrid query such that it can be executed, normalized, and merged to provide a single result. For example, a hybrid query can include a lexical clause, a semantic clause, and a keyword clause.

At block 205, the filtering module 114 pre-filters the vector space within the embedded repository 126 based on the entities extracted from the user query. In some embodiments, because entities from the pre-defined configuration are maintained as metadata within the embedded repository 126, the filtering module 114 can pre-filter embedded documents within the embedded repository 126 such that only documents containing the stored entities are ultimately semantically searched.

At block 206, the similarity analysis module 116 identifies documents relevant to the user query from the pre-filtered vector space using the hybrid query. For example, the similarity analysis module 116 can perform various similarity analysis techniques on the embedded user query to identify relevant documents from within the pre-filtered, embedded dataset of forms, documents, and models within the embedded repository 126. In some embodiments, the similarity analysis can include cosine similarity techniques. For example, the similarity analysis module 116 may, based on the embedded user inquiry, rank and retrieve the top “n” most relevant documents within the embedded repository 126. In addition, the scoring performed by the similarity analysis module 116 can include a combined score that can be calculated using a weighted sum where different weights can be assigned to the contribution from the keyword match score, the vector similarity score, and the lexical score

At block 207, the prompt generation module 118 parses the documents identified at block 206 to identify information relevant to the hybrid query. For example, for an identified document, the prompt generation module 118 can search the entire document and parse its text. The prompt generation module 118 can compare certain semantic keywords from the received user query to the text within the identified document and retrieve the most relevant passages, which in one embodiment may be based on textual similarity scores. The prompt generation module 118 can parse information such as titles, due dates, submission mechanisms, shareholder/partner types, document purposes, information that the form requires, calculations, instructions, conditions, and the like, although these are not limiting and are merely exemplary in nature.

At block 208, the prompt generation module 118 generates a prompt based on the user query and the information parsed from the relevant documents. In some embodiments, the prompt is generated as an input to an LLM, such as LLM module 120, and is therefore a textual prompt. In some embodiments, the prompt generation module 118 combines the documents identified as relevant from the hybrid semantic searching of the embedded repository 126 with the original user query to form the LLM prompt.

At block 209, the prompt generation module 118 feeds the generated prompt to the LLM module 120, and, at block 210, the LLM module 120 analyzes the query, as well as the additional relevant information provided in the prompt as context to generate an answer responsive to the user query. At block 211, the server 106 receives the generated response form the LLM module 120 and, at block 212, the server 106 transmits the response to the user device 102 where it can be displayed.

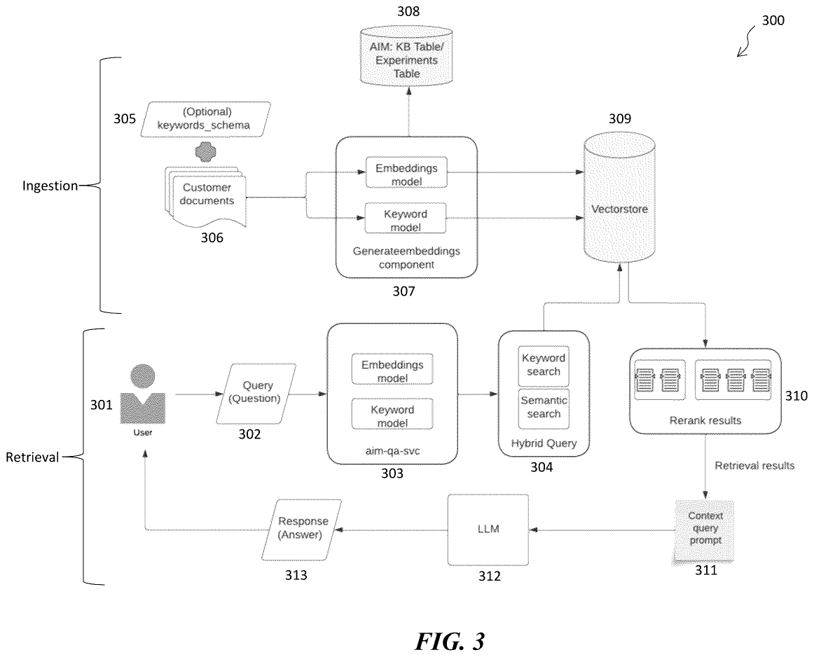

FIG. 3 is an example architectural flow 300 for performing keyword-assisted semantic searching according to example embodiments of the present disclosure. The flow 300 begins at 301 when a user supplies a query (i.e., a question) 302 via his/her user device 102. Prior to any analysis being performed on the received user query, additional pre-processing can be performed in the ingestion section of the architectural flow 300.

For example, a keyword schema or other pre-defined configuration including a list of unique entities can be provided by a user at 305. In addition, customer documents 306 can be provided and analyzed, for example documents contained within the form repository 124. At 307, the entity extraction module 110 extracts keywords/entities from the customer documents 306 and the embedding module 108 embeds the customer documents 306 to a vector space. Then, the embedded documents are stored within the vectorstore 309 (e.g., the embedded repository 126). Moreover, the keyword management module 122 can maintain the keywords/entities extracted from the customer documents 306 and provided by the user as metadata within the vectorstore 309.

In the retrieval section, at 303, the embedding module 108 embeds the user query 302 to the vector space and the entity extraction module 110 extracts one or more entities from the user query. At 304, the hybrid query generation module 112 generates a hybrid query based on the embedded user query and the one or more entities extracted from the query. Then, the similarity analysis module 116 conducts a hybrid keyword/semantic search of the hybrid query across the vectorstore 309 and re-ranks the results at 310 in accordance with the scoring principles discussed herein.

At 311, the prompt generation module 118 generates an LLM input by compiling the user query and the information parsed from the relevant documents identified during the hybrid semantic search of the vectorstore 309. At 312, the prompt generation module 118 feeds the generated input to the LLM module 120. At 313, the LLM module 120 analyzes the query, as well as the additional relevant information provided in the input as context to generate an answer responsive to the user query. The resulting answer is ultimately provided back to the user.

FIG. 4 is an example hybrid query 400 according to example embodiments of the present disclosure. The query 400 can include a lexical clause 401, a semantic clause 402, and a keyword clause 403. In some embodiments, a score can be calculated for each. For example, a lexical score s₁ can be calculated for the lexical clause 401, a vector similarity score s₂ can be calculated for the semantic clause 402, and a keyword match score ss can be calculated for the keyword clause 403. Then, the scores can be weighted to calculate a normalized score 404.

FIG. 5 is a diagram of an example server 500 that can be used within system 100 of FIG. 1 (i.e., as server 106). Server 500 can implement various features and processes as described herein. Server 500 can be implemented on any electronic device that runs software applications derived from complied instructions, including without limitation personal computers, servers, smart phones, media players, electronic tablets, game consoles, email devices, etc. In some implementations, server 500 can include one or more processors 502, volatile memory 504, non-volatile memory 506, and one or more peripherals 508. These components can be interconnected by one or more computer buses 510.

Processor(s) 502 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 510 can be any known internal or external bus technology, including but not limited to ISA, EISA, PCI, PCI Express, USB, Serial ATA, or FireWire. Volatile memory 504 can include, for example, SDRAM. Processor 502 can receive instructions and data from a read-only memory or a random access memory or both. Essential elements of a computer can include a processor for executing instructions and one or more memories for storing instructions and data.

Non-volatile memory 506 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 506 can store various computer instructions including operating system instructions 512, communication instructions 514, application instructions 516, and application data 517. Operating system instructions 512 can include instructions for implementing an operating system (e.g., Mac OS®, Windows®, or Linux). The operating system can be multi-user, multiprocessing, multitasking, multithreading, real-time, and the like. Communication instructions 514 can include network communications instructions, for example, software for implementing communication protocols, such as TCP/IP, HTTP, Ethernet, telephony, etc. Application instructions 516 can include instructions for various applications. Application data 517 can include data corresponding to the applications.

Peripherals 508 can be included within server device 500 or operatively coupled to communicate with server device 500. Peripherals 508 can include, for example, network subsystem 518, input controller 520, and disk controller 522. Network subsystem 518 can include, for example, an Ethernet of WiFi adapter. Input controller 520 can be any known input device technology, including but not limited to a keyboard (including a virtual keyboard), mouse, track ball, and touch-sensitive pad or display. Disk controller 522 can include one or more mass storage devices for storing data files; such devices include magnetic disks, such as internal hard disks and removable disks; magneto-optical disks; and optical disks.

FIG. 6 is an example computing device that can be used within the system 100 of FIG. 1, according to an embodiment of the present disclosure. In some embodiments, device 600 can be a user device 102. The illustrative user device 600 can include a memory interface 602, one or more data processors, image processors, central processing units 604, and or secure processing units 605, and peripherals subsystem 606. Memory interface 602, one or more central processing units 604 and or secure processing units 605, and or peripherals subsystem 606 can be separate components or can be integrated in one or more integrated circuits. The various components in user device 600 can be coupled by one or more communication buses or signal lines.

Sensors, devices, and subsystems can be coupled to peripherals subsystem 606 to facilitate multiple functionalities. For example, motion sensor 610, light sensor 612, and proximity sensor 614 can be coupled to peripherals subsystem 606 to facilitate orientation, lighting, and proximity functions. Other sensors 616 can also be connected to peripherals subsystem 606, such as a global navigation satellite system (GNSS) (e.g., GPS receiver), a temperature sensor, a biometric sensor, magnetometer, or other sensing device, to facilitate related functionalities.

Camera subsystem 620 and optical sensor 622, e.g., a charged coupled device (CCD) or a complementary metal-oxide semiconductor (CMOS) optical sensor, can be utilized to facilitate camera functions, such as recording photographs and video clips. Camera subsystem 620 and optical sensor 622 can be used to collect images of a user to be used during authentication of a user, e.g., by performing facial recognition analysis.

Communication functions can be facilitated through one or more wired and or wireless communication subsystems 624, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 624. The specific design and implementation of communication subsystems 624 can depend on the communication network(s) over which the user device 600 is intended to operate. For example, user device 600 can include communication subsystems 624 designed to operate over a GSM network, a GPRS network, an EDGE network, a WiFi or WiMax network, and a Bluetooth™ network. For example, wireless communication subsystems 624 can include hosting protocols such that device 600 can be configured as a base station for other wireless devices and or to provide a WiFi service.

Audio subsystem 626 can be coupled to speaker 628 and microphone 630 to facilitate voice-enabled functions, such as speaker recognition, voice replication, digital recording, and telephony functions. Audio subsystem 626 can be configured to facilitate processing voice commands, voice-printing, and voice authentication, for example.

I/O subsystem 640 can include a touch-surface controller 642 and or other input controller(s) 644. Touch-surface controller 642 can be coupled to a touch-surface 646. Touch-surface 646 and touch-surface controller 642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 646.

The other input controller(s) 644 can be coupled to other input/control devices 648, such as one or more buttons, rocker switches, thumb-wheel, infrared port, USB port, and or a pointer device such as a stylus. The one or more buttons (not shown) can include an up/down button for volume control of speaker 628 and or microphone 630.

In some implementations, a pressing of the button for a first duration can disengage a lock of touch-surface 646; and a pressing of the button for a second duration that is longer than the first duration can turn power to user device 600 on or off. Pressing the button for a third duration can activate a voice control, or voice command, module that enables the user to speak commands into microphone 630 to cause the device to execute the spoken command. The user can customize a functionality of one or more of the buttons. Touch-surface 646 can, for example, also be used to implement virtual or soft buttons and or a keyboard.

In some implementations, user device 600 can present recorded audio and or video files, such as MP3, AAC, and MPEG files. In some implementations, user device 600 can include the functionality of an MP3 player, such as an iPod™. User device 600 can, therefore, include a 36-pin connector and or 8-pin connector that is compatible with the iPod. Other input/output and control devices can also be used.

Memory interface 602 can be coupled to memory 650. Memory 650 can include high-speed random access memory and or non-volatile memory, such as one or more magnetic disk storage devices, one or more optical storage devices, and or flash memory (e.g., NAND, NOR). Memory 650 can store an operating system 652, such as Darwin, RTXC, LINUX, UNIX, OS X, Windows, or an embedded operating system such as VxWorks.

Operating system 652 can include instructions for handling basic system services and for performing hardware dependent tasks. In some implementations, operating system 652 can be a kernel (e.g., UNIX kernel). In some implementations, operating system 652 can include instructions for performing voice authentication.

Memory 650 can also store communication instructions 654 to facilitate communicating with one or more additional devices, one or more computers and or one or more servers. Memory 650 can include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic messaging-related process and functions; web browsing instructions 664 to facilitate web browsing-related processes and functions; media processing instructions 666 to facilitate media processing-related functions and processes; GNSS/Navigation instructions 668 to facilitate GNSS and navigation-related processes and instructions; and or camera instructions 670 to facilitate camera-related processes and functions.

Memory 650 can store application (or “app”) instructions and data 672, such as instructions for the apps described above in the context of FIGS. 1-4. Memory 650 can also store other software instructions 674 for various other software applications in place on device 600.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computing system comprising:
a processor; and
a non-transitory computer-readable storage device storing computer-executable instructions, the instructions when executed by the processor cause the processor to perform operations comprising:
receiving a query from a user device;
embedding the received query to a vector space comprising a plurality of embedded documents;
extracting one or more entities from the received query based on a pre-defined configuration of entities;
generating a hybrid query based on the extracted entities and the received query;
pre-filtering the vector space based on the extracted entities;
identifying one or more documents relevant to the hybrid query from the pre-filtered vector space;
generating an input based on the user query and information parsed from the one or more identified documents;
analyzing the input with a large language model (LLM);
receiving a response to the query from the LLM; and
transmitting the response to the user device.

2. The computing system of claim 1, wherein identifying the one or more documents relevant to the hybrid query comprises performing a similarity analysis on the hybrid user query and the plurality of embedded documents.

3. The computing system of claim 2, wherein performing the similarity analysis comprises performing a cosine similarity ranking of embedded documents within the plurality of embedded documents.

4. The computing system of claim 2, wherein performing the similarity analysis comprises identifying and ranking a predefined number of relevant embedded documents based on a relevance to the query.

5. The computing system of claim 1, wherein the operations further comprise:
receiving a list of pre-defined entities from the user device; and
adding the list of pre-defined entities to the pre-defined configuration.

6. The computing system of claim 1, wherein the pre-defined configuration is persisted as metadata within the vector space.

7. The computing system of claim 1, wherein the operations further comprise:
accessing the plurality of embedded documents;
extracting one or more keywords from the plurality of embedded documents; and
persisting the one or more extracted keywords as metadata within the vector space.

8. The computing system of claim 7, wherein extracting the one or more keywords from the plurality of embedded documents comprises extracting the one or more keywords using the LLM.

9. The computing system of claim 8, wherein extracting the one or more keywords using the LLM comprises extracting the one or more keywords in a zero-shot fashion.

10. The computing system of claim 1, wherein generating the hybrid query comprises generating a query comprising a lexical clause, a semantic clause, and a keyword clause.

11. A computer-implemented method, performed by at least one processor, comprising:
receiving a query from a user device;
embedding the received query to a vector space comprising a plurality of embedded documents;
extracting one or more entities from the received query based on a pre-defined configuration of entities;
generating a hybrid query based on the extracted entities and the received query;
pre-filtering the vector space based on the extracted entities;
identifying one or more documents relevant to the hybrid query from the pre-filtered vector space;
generating an input based on the user query and information parsed from the one or more identified documents;
analyzing the input with a large language model (LLM);
receiving a response to the query from the LLM; and
transmitting the response to the user device.

12. The computer-implemented method of claim 11, wherein identifying the one or more documents relevant to the hybrid query comprises performing a similarity analysis on the hybrid user query and the plurality of embedded documents.

13. The computer-implemented method of claim 12, wherein performing the similarity analysis comprises performing a cosine similarity ranking of embedded documents within the plurality of embedded documents.

14. The computer-implemented method of claim 12, wherein performing the similarity analysis comprises identifying and ranking a predefined number of relevant embedded documents based on a relevance to the query.

15. The computer-implemented method of claim 11 further comprising:
receiving a list of pre-defined entities from the user device; and
adding the list of pre-defined entities to the pre-defined configuration.

16. The computer-implemented method of claim 11, wherein the pre-defined configuration is persisted as metadata within the vector space.

17. The computer-implemented method of claim 11 further comprising:
accessing the plurality of embedded documents;
extracting one or more keywords from the plurality of embedded documents; and
persisting the one or more extracted keywords as metadata within the vector space.

18. The computer-implemented method of claim 17, wherein extracting the one or more keywords from the plurality of embedded documents comprises extracting the one or more keywords using the LLM.

19. The computer-implemented method of claim 18, wherein extracting the one or more keywords using the LLM comprises extracting the one or more keywords in a zero-shot fashion.

20. The computer-implemented method of claim 11, wherein generating the hybrid query comprises generating a query comprising a lexical clause, a semantic clause, and a keyword clause.
